(19) United States
(12) Patent Application Publication
(10) Pub. No.: US 2023/0316826 A1
(43) Pub. Date: Oct. 5, 2023

(54) INFORMATION PROCESSING APPARATUS, COMPUTER-READABLE STORAGE MEDIUM, AND INFORMATION PROCESSING METHOD

(71) Applicant: HONDA MOTOR CO.,LTD., Tokyo (JP)

(72) Inventors: Shunji KAMO, Saitama (JP); Kazuhiro KODAIRA, Saitama (JP)

(21) Appl. No.: 18/177,775

(22) Filed: Mar. 3, 2023

(30) Foreign Application Priority Data
Mar. 31, 2022 (JP) 2022-060386

(51) Int. Cl. G07C 5/08; G07C 5/00

(52) U.S. Cl. CPC G07C 5/0808; G07C 5/008

(57) ABSTRACT

An information processing apparatus includes: an event detection unit configured to detect an occurrence of one or more predetermined types of events; a sensing information acquisition unit configured to acquire, when the occurrence of an event is detected, sensing information representing whether an occupant of a mobile object has sensed an anomaly of the mobile object; a mobile object information acquisition unit configured to acquire mobile object information of a period having a predetermined length, which includes a time point at which the occurrence of the event has been detected, the mobile object information being information representing an output of a sensor mounted on the mobile object or a state of the mobile object; and a cause estimation unit configured to estimate a cause of the anomaly based on the mobile object information obtained when the occupant has sensed the anomaly of the mobile object.

### BACKGROUND

### 1. Technical Field

The present invention relates to an information processing apparatus, a computer-readable storage medium, and an information processing method.

### 2. Related Art

Patent Documents 1 to 4 disclose techniques of identifying vehicle data before and after a timing at which a user has felt uncomfortable in a behavior of a vehicle, and appropriately clarifying a cause of the user feeling uncomfortable in the behavior of the vehicle. Patent Document 5 discloses a remote failure diagnosis system including a vehicle configured to transmit vehicle data related to a stressor of a predetermined in-vehicle component at a predetermined timing, and a failure diagnosis server which performs a failure diagnosis of the in-vehicle component of the vehicle. PRIOR ART DOCUMENTS

### PATENT DOCUMENTS

Patent Document 1: Japanese Patent Application Publication No. 2017-141025
Patent Document 2: Japanese Patent Application Publication No. 2014-201085
Patent Document 3: Japanese Patent Application Publication No. 2002-331884
Patent Document 4: Japanese Patent Application Publication No. 2002-109690
Patent Document 5: Japanese Patent Application Publication No. 2008-001233

### BRIEF DESCRIPTION OF THE DRAWINGS

FIG. 1 schematically shows an example of a system configuration of an anomaly detection system 100.

FIG. 2 schematically shows an example of information processing in the anomaly detection system 100.

FIG. 3 schematically shows an example of an internal configuration of a vehicle 20.

FIG. 4 schematically shows an example of an internal configuration of a management server 110.

FIG. 5 schematically shows an example of an internal configuration of a cause estimation unit 432.

FIG. 6 schematically shows an example of a data structure of a database 600.

FIG. 7 schematically shows an example of a data structure of a database 700.

FIG. 8 schematically shows an example of an internal configuration of a cause component extraction unit 520.

FIG. 9 schematically shows an example of an internal configuration of a cause component extraction unit 920.

FIG. 10 schematically shows an example of an internal configuration of a cause component extraction unit 1020.

FIG. 11 schematically shows an example of an internal configuration of a computer 3000.

### DESCRIPTION OF EXEMPLARY EMBODIMENTS

Hereinafter, embodiments of the present invention will be described, but the embodiments do not limit the invention according to the claims. In addition, not all of the combinations of features described in the embodiments are essential to the solving means of the invention. It is to be noted that in the drawings, same or similar parts are assigned with same reference signs, and duplicated descriptions may be omitted.

(Overview of anomaly detection system 100)

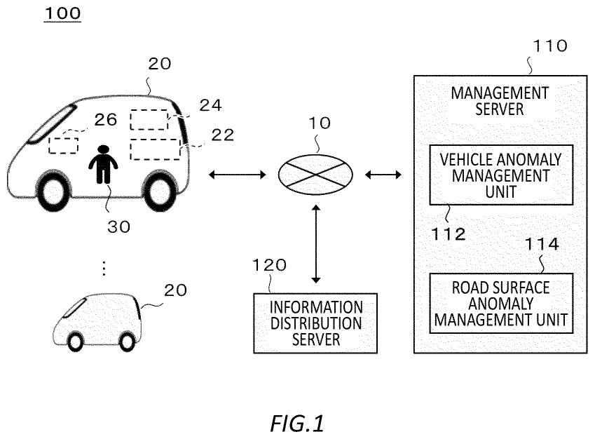

FIG. 1 schematically shows an example of a system configuration of an anomaly detection system 100. In the present embodiment, the anomaly detection system 100 will be described in detail while taking a case where the anomaly detection system 100 detects an anomaly related to a state of each of one or more vehicles 20 to be managed and/or an anomaly related to the traveling environment of each of the one or more vehicles 20, as an example. An example of a state of the traveling environment of the one or more vehicles 20 is a state of a road surface.

In the present embodiment, the anomaly detection system 100 includes a management server 110 and an information distribution server 120. In the present embodiment, the management server 110 includes a vehicle anomaly management unit 112 and a road surface anomaly management unit 114. In the present embodiment, the vehicle 20 includes a main component group 22, a sensor set 24, and an input/output unit 26.

(Overview of each unit relevant to anomaly detection system 100)

In the present embodiment, a communication network 10 is used to transmit information. The communication network 10 may be a transmission path for wired communication, may be a transmission path for wireless communication, or may be a combination of the transmission path for wireless communication and the transmission path for wired communication. The communication network 10 may include a wireless packet communication network, the Internet, a P2P network, a dedicated line, a VPN, a power line communication line, a vehicle-to-vehicle communication line, a road-to-vehicle communication line, or the like. The communication network 10 (i) may include a mobile communication network such as a mobile phone line network, and (ii) may include a wireless communication network such as a wireless MAN (for example, WiMAX (registered trademark)), a wireless LAN (for example, Wi-Fi (registered trademark)), Bluetooth (registered trademark), Zigbee (registered trademark), or near field communication (NFC).

In the present embodiment, the vehicle 20 provides a moving service to an occupant 30. For example, the vehicle 20 moves to a location designated by the occupant 30, carrying the occupant 30. The vehicle 20 may be operated manually, or may have a self-driving function or a remote driving function. The vehicle 20 may be a self-driving vehicle.

Examples of the vehicle 20 include an automobile, a motorcycle, a bicycle, a standing-type vehicle including a power unit, and the like. Examples of the automobile include an electric vehicle, a fuel-cell vehicle, a hybrid vehicle, a compact commuter, an electric cart, and the like. Examples of the motorcycle include a motorbike, a three-wheeler, and the like. The vehicle 20 will be described later in detail.

The main component group 22 includes a plurality of components for realizing a movement of the vehicle 20. The main component group 22 will be described later in detail.

The sensor set 24 includes one or more sensors. The sensor set 24 transmits, to the management server 110, (i) information representing an output of each of the one or more sensors, and/or (ii) information representing a state of the vehicle 20 that has been determined based on the output of at least one of the one or more sensors (these pieces of information may be referred to as vehicle data). The vehicle data may include information representing a time at which a measurement result of the above-described sensor has been output and/or information representing a location of the vehicle 20 obtained when the measurement result of the above-described sensor has been output.

The sensor set 24 includes, for example, one or more sensors for measuring various physical quantities that represent a state of the vehicle 20. Examples of the state of the vehicle 20 include a state of a response to a driver operation, a state of a sound sensed by an occupant, a vibration state, a state of air inside the vehicle, a battery state, a state of electrical power consumption, and the like. Examples of the state of a response include states of dullness of an acceleration by a pedal operation, a delay of a turn by a steering wheel operation, a braking distance by a brake, a pedal reaction force by a brake regeneration, sliding door opening/closing speed, and the like. Examples of the state of a sound include states of a magnitude of a squeaking sound inside the vehicle, a traveling sound/wind noise from outside the vehicle, and the like. Examples of the state of air include a state of an odor inside the vehicle, an air conditioning state, and the like. Examples of the battery state include states of a time required until the battery is fully charged, reduction speed of a remaining battery amount, an upper limit value of a battery capacity, and the like.

Examples of the above-described physical quantity include an acceleration [m/s²], vibration [Hz], a sound pressure [dB], a yaw rate [rad/sec], a voltage [A], a current [V], a battery capacity [Wh], an odor [ppm], wind speed [m/h], and the like. It is to be noted that the type of the physical quantity measured by the sensor is not limited in particular as long as the physical quantity described above that may represent the state of the vehicle 20 is obtained. For example, the above-described sensor may include a hexaxial gyroscope sensor which measures an acceleration and/or pitching of the vehicle 20, or may include a temperature sensor which measures a substrate temperature of an electronic component. The above-described sensor may include a sensor which measures an odor of an air conditioner, a sensor which measures wind speed of the air conditioner, a sensor which measures a degree of a stain or color fade-out of a seat, and a sensor which measures a degree of a polish or stain of a vehicle body.

The sensor set 24 includes, for example, one or more sensors for measuring an operation amount of the vehicle 20 by the occupant 30. Examples of the operation to the vehicle 20 include an accelerator operation, a brake operation, a steering wheel operation, an air conditioning operation, a window opening/closing operation, a wiper operation, a light-on operation, a parking brake operation, a navigation screen operation, a door opening/closing operation, an interior lighting operation, a blinker operation, a mirror opening/closing operation, a sun visor operation, a charging/discharging connector insertion/removal operation, a seat position movement operation, an ignition switch operation, a shift switch operation, and the like.

The sensor set 24 includes, for example, one or more sensors for observing a behavior of the occupant 30. Examples of the above-described sensors include a camera, a point group sensor, a microphone, and the like.

In the present embodiment, the input/output unit 26 functions as a user interface between the vehicle 20 and the occupant 30. Examples of the input/output unit 26 include a steering wheel, an accelerator, a brake, a switch, a navigation system, a display, a speaker, a camera, a microphone, and the like. The input/output unit 26 may use an agent that provides a voice interaction service or a gesture interaction service to the occupant 30, to exchange information with the occupant 30.

For example, the input/output unit 26 outputs various types of information to the occupant 30. In one embodiment, the input/output unit 26 inquires of the occupant 30 on various matters based on an instruction from the management server 110. For example, when the management server 110 detects an occurrence of a predetermined type of event, the management server 110 inquires of the occupant 30 on various matters via the input/output unit 26. The above-described event will be described later in detail. In another embodiment, the input/output unit 26 receives information distributed by the information distribution server 120, and presents the information to the occupant 30.

For example, the input/output unit 26 accepts an input from the occupant 30. In one embodiment, the input/output unit 26 accepts a response to various inquiries from the occupant 30. For example, the input/output unit 26 accepts a response from the occupant 30 to the inquiry described above from the management server 110. The above-described response will be described later in detail. In another embodiment, the input/output unit 26 accepts an input related to an operation of the vehicle 20 from the occupant 30. As described above, the examples of the operation to the vehicle 20 include the accelerator operation, the brake operation, the steering wheel operation, air conditioning operation, the opening/closing operation, the wiper operation, the light-on operation, the parking brake operation, the navigation screen operation, the door opening/closing operation, the interior lighting operation, the blinker operation, the mirror opening/closing operation, the sun visor operation, the charging/discharging connector insertion/removal operation, the seat position movement operation, the ignition switch operation, the shift switch operation, and the like.

The occupant 30 gets on board the vehicle 20. The occupant 30 may be an owner of the vehicle 20 who owns the vehicle 20, or may be a user of the vehicle 20 who temporarily uses the vehicle 20.

When the occupant 30 senses an anomaly of the vehicle 20 during a period in which the occupant 30 is on board the vehicle 20, the occupant 30 inputs information representing that the anomaly has been sensed to the input/output unit 26. The input/output unit 26 transmits information representing that the occupant 30 has sensed the anomaly to the management server 110. Examples of the above-described anomaly include an anomaly related to an exterior and/or interior appearance of the vehicle 20, an anomaly related to a sound, vibration, and/or odor generated by the vehicle 20, an anomaly related to a response to a driver operation, an anomaly related to an electrical power consumption degree, an anomaly related to wind speed, and the like.

The occupant 30 may respond, in response to an inquiry from the input/output unit 26, that is related to an anomaly of the vehicle 20, whether the occupant 30 has sensed the anomaly. When the occupant 30 has sensed the anomaly of the vehicle 20, the occupant 30 may input, to the input/output unit 26, information representing a type of the anomaly sensed by the occupant 30.

For example, when the occupant 30 responds, in response to an inquiry from the input/output unit 26, that is related to the presence or absence of an anomaly of the vehicle 20, that an anomaly has been sensed, the input/output unit 26 inquires of the occupant 30 on a type of the anomaly sensed by the occupant 30. In response to the inquiry from the input/output unit 26, the occupant 30 responds the type of the anomaly sensed by the occupant 30.

The anomaly type is represented by, for example, at least one of (i) a type of a sensation with which an anomaly has been sensed or a type of a physical quantity representing the anomaly, (ii) a position at which the anomaly is considered to be occurring, (iii) a degree of the anomaly, (iv) a frequency at which the anomaly occurs, or (v) a combination thereof. Examples of the type of the sensation with which the anomaly has been sensed include a visual sensation, an auditory sensation, an olfactory sensation, a tactile sensation, and the like. Examples of the type of the physical quantity representing an anomaly include an appearance, a sound, an odor, vibration, the speed of a response to a driver operation, electrical power consumption speed, wind speed, and the like.

In the present embodiment, the management server 110 manages each of the one or more vehicles 20. The management server 110 may manage information related to a state of each of the one or more vehicles 20. For example, the management server 110 manages (i) presence or absence of an anomaly related to a state of each of the one or more vehicles 20, and/or (ii) a type of the anomaly related to the state of each of the one or more vehicles 20. The management server 110 may also manage information related to a state of the traveling environment of each of the one or more vehicles 20.

In the present embodiment, the vehicle anomaly management unit 112 manages information related to an anomaly of each of the one or more vehicles 20.

For example, the vehicle anomaly management unit 112 acquires, from each of the one or more vehicles 20, vehicle data output from each vehicle, and manages the vehicle data. As described above, the vehicle data includes (i) information representing an output of each of the one or more sensors, and/or (ii) information representing a state of the vehicle 20 that has been determined based on the output of at least one of the one or more sensors.

For example, the vehicle anomaly management unit 112 acquires, from each of the one or more vehicles 20, information representing a content of a response of the occupant 30 to various inquiries (may be referred to as response data), and manages the response data. Based on vehicle data obtained when the occupant 30 has sensed an anomaly of the vehicle 20, the vehicle anomaly management unit 112 estimates a cause of the anomaly. Accordingly, the vehicle anomaly management unit 112 can accurately estimate the cause of the anomaly.

For example, based on vehicle data obtained when the occupant 30 has not sensed an anomaly of the vehicle 20 and vehicle data obtained when the occupant 30 has sensed an anomaly of the vehicle 20, the vehicle anomaly management unit 112 estimates the cause of the anomaly. Accordingly, the vehicle anomaly management unit 112 can more accurately estimate the cause of the anomaly. The vehicle anomaly management unit 112 will be described later in detail.

In the present embodiment, the road surface anomaly management unit 114 manages information related to an anomaly of a road on which at least one of the one or more vehicles 20 has traveled in the past. For example, based on a plurality of pieces of data collected from the one or more vehicles 20, the road surface anomaly management unit 114 identifies a location at which an anomaly is frequently sensed (may be referred to as frequent anomaly-occurring location). The road surface anomaly management unit 114 outputs information representing the identified frequent anomaly-occurring location to the information distribution server 120. The road surface anomaly management unit 114 will be described later in detail.

In the present embodiment, the information distribution server 120 distributes various types of information to each of the one or more vehicles 20. The information distribution server 120 may alternatively distribute the various types of information to the owner or user of each of the one or more vehicles 20. The information distribution server 120 may also notify at least some of the one or more vehicles 20 of particular information. The information distribution server 120 may alternatively notify the owner or user of at least some of the one or more vehicles 20 of the particular information.

For example, the information distribution server 120 notifies at least some of the one or more vehicles 20 of information representing the frequent anomaly-occurring location described above. The information distribution server 120 may notify, out of the one or more vehicles 20, the vehicle 20 located near the frequent anomaly-occurring location or the owner or user thereof of the information representing the frequent anomaly-occurring location. The information distribution server 120 may notify, out of the one or more vehicles 20, the vehicle 20 in which deterioration of a particular component has progressed more than a predetermined reference or the owner or user thereof of the information representing the frequent anomaly-occurring location.

(Specific Configuration of Each Unit of Anomaly Detection System 100)

Each unit of the anomaly detection system 100 may be realized by hardware, software, or a combination of hardware and software. At least a part of each unit of the anomaly detection system 100 may be realized by a single server, or may be realized by a plurality of servers. At least a part of each unit of the anomaly detection system 100 may be realized on a virtual machine or a cloud system. At least a part of each unit of the anomaly detection system 100 may be realized by a personal computer or a mobile terminal. Examples of the mobile terminal can include a mobile phone, a smartphone, a PDA, a tablet, a notebook computer or a laptop computer, a wearable computer, and the like. Each unit of the anomaly detection system 100 may store information using a distributed ledger technology such as blockchain or a distributed network.

When at least some of the constituent elements constituting the anomaly detection system 100 are realized by software, the constituent elements realized by the software may be realized by activating software or a program defining operations related to the constituent elements in an information processing apparatus having a general configuration. The above-described information processing apparatus having a general configuration may include (i) a data processing apparatus including a processor such as a CPU and a GPU, a ROM, a RAM, a communication interface, and the like, (ii) an input apparatus such as a keyboard, a pointing device, a touch panel, a camera, a voice/sound input apparatus, a gesture input apparatus, various sensors, and a GPS receiver, (iii) an output apparatus such as a display apparatus, a voice/sound output apparatus, and a vibration apparatus, and (iv) a storage apparatus (including an external storage apparatus) such as a memory, an HDD, and an SSD.

In the above-described information processing apparatus having a general configuration, the above-described data processing apparatus or storage apparatus may store the above-described software or program. By being executed by a processor, the above-described software or program causes the above-described information processing apparatus to execute operations defined by the software or program. The above-described software or program may be stored in a non-transitory computer-readable recording medium. The above-described software or program may be a program for causing a computer to function as the anomaly detection system 100 or a part thereof. The above-described software or program may be a program for causing the computer to execute an information processing method in the anomaly detection system 100 or a part thereof.

The information processing method executed in each unit of the anomaly detection system 100 includes, for example, an event detection step of detecting an occurrence of one or more predetermined types of events regarding a mobile object. The above-described information processing method includes, for example, a sensing information acquisition step of acquiring, when the occurrence of an event is detected in the event detection step, sensing information representing whether an occupant of the mobile object has sensed an anomaly of the mobile object. The above-described information processing method includes, for example, a mobile object information acquisition step of acquiring mobile object information of a period having a predetermined length, which includes a time point at which the occurrence of the event has been detected in the event detection step, the mobile object information being information representing an output of a sensor mounted on the mobile object or information representing a state of the mobile object that has been determined based on the output. The above-described information processing method includes, for example, a cause estimation step of estimating a cause of the anomaly based on the mobile object information obtained when the occupant has sensed the anomaly of the mobile object. Each step of the above-described information processing method is executed by a computer, for example.

The vehicle 20 may be an example of the mobile object. The main component group 22 may be an example of the plurality of components. Each of the one or more sensors included in the sensor set 24 may be an example of the sensor. The response data may be an example of the sensing information. The information representing that the occupant 30 has sensed the anomaly may be an example of the sensing information. The information representing a type of the anomaly sensed by the occupant 30 may be an example the sensing information. The vehicle data may be an example of the mobile object information.

### Example of Another Embodiment

In the present embodiment, the mobile object has been described in detail while taking the case where the mobile object is the vehicle 20 as an example. However, the mobile object is not limited to the present embodiment. Other examples of the mobile object include a marine vessel, a flight vehicle, and the like. Examples of the marine vessel include a ship, a hovercraft, a water bike, a submarine, a submersible craft, an underwater scooter, and the like. Examples of the flight vehicle include an air plane, an air ship or a balloon, a hot-air balloon, a helicopter, a drone, and the like.

In the present embodiment, the anomaly detection system 100 has been described in detail while taking the case where the anomaly detection system 100 exchanges information with the occupant 30 via the input/output unit 26 of the vehicle 20, as an example. However, the anomaly detection system 100 is not limited to the present embodiment. In another embodiment, the anomaly detection system 100 may exchange information with the occupant 30 via a communication terminal (not shown) that is used by the occupant 30. Examples of the communication terminal include a personal computer, a mobile terminal, and the like. Examples of the mobile terminal include a mobile phone, a smartphone, a PDA, a tablet, a notebook computer or a laptop computer, a wearable computer, and the like.

In the present embodiment, the anomaly detection system 100 has been described in detail while taking, as an example, the case where the management server 110 identifies a frequent anomaly-occurring location based on vehicle data of the one or more vehicles 20 and a response from the occupant 30, and the information distribution server 120 distributes information related to the identified frequent anomaly-occurring location to at least some of the one or more vehicles 20. However, the anomaly detection system 100 is not limited to the present embodiment. In another embodiment, some of the functions of the management server 110 according to the present embodiment may be realized by the information distribution server 120, and some of the functions of the information distribution server 120 according to the present embodiment may be realized by the management server 110.

In the present embodiment, the anomaly detection system 100 has been described in detail while taking, as an example, the case where the management server 110 detects an occurrence of a predetermined type of event and inquires of the occupant 30 on presence or absence of an anomaly of the vehicle 20 via the input/output unit 26 of the vehicle 20. However, the anomaly detection system 100 is not limited to the present embodiment. In another embodiment, the vehicle 20 may detect an occurrence of a predetermined type of event. In this case, the vehicle 20 may be an example of an event detection unit.

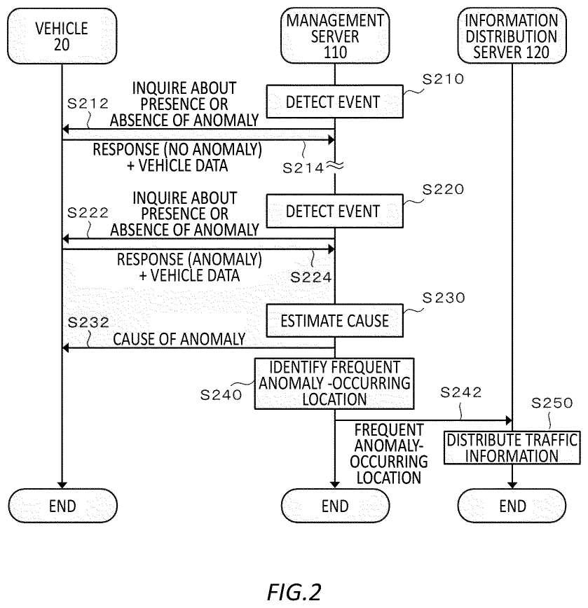

FIG. 2 schematically shows an example of information processing in the anomaly detection system 100. In the present embodiment, to facilitate understanding of the information processing in the anomaly detection system 100, the information processing in the anomaly detection system 100 will be described in detail while taking a case where, when the management server 110 detects a predetermined type of event, the vehicle 20 inquires of the occupant 30 on presence or absence of an anomaly, as an example.

According to the present embodiment, first, in Step 210 (Step may be abbreviated to S), the management server 110 detects an occurrence of a predetermined type of event. For example, the vehicle anomaly management unit 112 of the management server 110 detects an occurrence of at least one of one or more events. An example of the above-described type of the event is at least one of (i) an elapse of a predetermined period, (ii) an arrival of a predetermined time, (iii) an input of a predetermined type of instruction related to an operation of the vehicle 20, (iv) a match of a behavior of the occupant 30 with a predetermined condition, (v) a match of an output of the sensor set 24 of the vehicle 20 with a predetermined condition, or (vi) a match of a state of the vehicle 20 represented by vehicle data with a predetermined condition.

Examples of the predetermined type of instruction related to an operation of the vehicle 20 include abrupt steering, abrupt acceleration, hard braking, and the like. Examples of the case where the behavior of the occupant 30 matches a predetermined condition include (i) a case where the occupant 30 speaks a predetermined keyword or key phrase, (ii) a case where a feature of the behavior of the occupant 30 matches or is similar to a feature preregistered as a feature obtained when an anomaly is sensed, (iii) a case where the vehicle 20 is driven in a mode different from that of the other vehicles 20 in a periphery, and the like. Examples of the above-described preregistered feature (that is, a feature of the behavior of the occupant 30 when the occupant 30 has sensed an anomaly) include (i) the occupant 30 stopping the vehicle 20 even though a stop is not instructed by a traffic sign, a traffic light, or the like, (ii) the occupant 30 having a startled look, and the like.

Examples of the case where the output of the sensor set 24 of the vehicle 20 matches a predetermined condition or the case where the state of the vehicle 20 matches a predetermined condition include (i) a case where a speed, acceleration, angular acceleration, yaw rate, pitch rate, vibration, volume, or the like exceeding a predetermined threshold or a threshold corresponding to a location of the vehicle 20 is detected, (ii) a case where an obstacle is detected in a traveling direction of the vehicle 20, (iii) a case where the location of the vehicle 20 is deviated from a scheduled path or a region where the vehicle 20 is accepted to pass (for example, a road, a parking area, and the like), and the like. The threshold corresponding to the location of the vehicle 20 is determined based on, for example, location information of the vehicle 20 and traffic control applied at the location represented by the location information. The traffic control applied at each location may be determined based on road traffic sign information acquired by a camera mounted on the vehicle 20, or may be determined based on information acquired from an external information provision apparatus which distributes information related to the traffic control.

When the above-described occurrence of an event is detected in 5210, in 5212, the vehicle anomaly management unit 112 transmits, to the vehicle 20, an instruction for causing the vehicle 20 to execute processing for confirming whether the occupant 30 has sensed an anomaly of the vehicle 20 (may be referred to as anomaly confirmation processing). When the vehicle 20 receives the above-described instruction, the input/output unit 26 inquires of the occupant 30 on whether the occupant 30 has sensed an anomaly of the vehicle 20.

Next, in 5214, the input/output unit 26 accepts a response to the above-described inquiry from the occupant 30. According to the present embodiment, in 5214, for example, the occupant 30 transmits a fact that the occupant 30 has not sensed an anomaly of the vehicle 20 to the input/output unit 26.

In 5214, the input/output unit 26 transmits, to the vehicle anomaly management unit 112, response data representing a content of a response of the occupant 30 to the above-described inquiry. Accordingly, the vehicle anomaly management unit 112 can acquire information representing whether the occupant 30 has sensed an anomaly of the vehicle 20. Further, the input/output unit 26 transmits, to the vehicle anomaly management unit 112, vehicle data of a period having a predetermined length, which includes a time point at which the occurrence of an event has been detected. Accordingly, the vehicle anomaly management unit 112 can acquire vehicle data of the vehicle 20 in the above-described period.

The vehicle anomaly management unit 112 stores (i) identification information of a detected event or a time at which the event has been detected, (ii) response data, and (iii) vehicle data in a storage apparatus in association with one another. Accordingly, the vehicle anomaly management unit 112 can manage the vehicle data obtained when the occupant 30 has not sensed an anomaly of the vehicle 20.

Next, in 5220, the vehicle anomaly management unit 112 detects an occurrence of a predetermined type of event. The management server 110 detects the occurrence of an event by a procedure similar to the procedure described in 5210.

Next, in 5222, by a procedure similar to the procedure described in 5210, the vehicle anomaly management unit 112 transmits, to the vehicle 20, an instruction for causing the vehicle 20 to execute the anomaly confirmation processing. When the vehicle 20 receives the above-described instruction, the input/output unit 26 inquires of the occupant 30 on whether the occupant 30 has sensed an anomaly of the vehicle 20.

Next, in 5224, the input/output unit 26 accepts a response to the above-described inquiry from the occupant 30. According to the present embodiment, in 5224, for example, the occupant 30 transmits a fact that the occupant 30 has sensed an anomaly of the vehicle 20 to the input/output unit 26.

In 5224, the input/output unit 26 transmits, to the vehicle anomaly management unit 112, response data representing a content of the response of the occupant 30 to the above-described inquiry. Further, the input/output unit 26 transmits, to the vehicle anomaly management unit 112, vehicle data of a period having a predetermined length, which includes a time point at which the occurrence of an event has been detected.

The vehicle anomaly management unit 112 stores (i) identification information of a detected event or a time at which the event has been detected, (ii) response data, and (iii) vehicle data in the storage apparatus in association with one another. Accordingly, the vehicle anomaly management unit 112 can manage the vehicle data obtained when the occupant 30 has sensed an anomaly of the vehicle 20.

Next, in 5230, the vehicle anomaly management unit 112 estimates a cause of the anomaly based on the vehicle data obtained when the occupant 30 has sensed the anomaly of the vehicle 20. The vehicle anomaly management unit 112 may estimate the cause of the anomaly based on vehicle data obtained when the occupant 30 has sensed the anomaly of the vehicle 20 and vehicle data obtained when the occupant 30 has not sensed an anomaly of the vehicle 20. The anomaly cause estimation processing will be described later in detail.

Next, in 5240, the road surface anomaly management unit 114 identifies a location where a frequency at which an anomaly is sensed is higher than a predetermined value (for example, the frequent anomaly-occurring location described above) based on the response data and the vehicle data from the one or more vehicles 20. The frequent anomaly-occurring location may be a particular point or a particular region.

As described above, each piece of vehicle data includes information representing a location of the vehicle 20 obtained when a measurement result of the sensor is output, for example. Further, for example, the vehicle anomaly management unit 112 stores the response data and the vehicle data in association with each other for each event. For example, the road surface anomaly management unit 114 subjects the above-described data to statistical processing, and derives a frequency at which an anomaly is sensed for each section having an appropriate geographical range, to thus identify the frequent anomaly-occurring location. The road surface anomaly management unit 114 may identify the frequent anomaly-occurring location for the weekdays and non-working days, respectively, may identify the frequent anomaly-occurring location for each day of the week, or may identify the frequent anomaly-occurring location for each time of day.

Next, in 5250, the information distribution server 120 distributes traffic information to the one or more vehicles 20 or the owner or user thereof. The traffic information may include information related to the frequent anomaly-occurring location. As described above, the information distribution server 120 may notify at least some of the one or more vehicles 20 or the owners or users thereof of the traffic information including the information related to the frequent anomaly-occurring location. The information distribution server 120 may notify at least some of the one or more vehicles 20 or the owners or users thereof of traffic information including information representing a detour route or an avoidance route.

### Example of Another Embodiment

In the present embodiment, the information processing in the anomaly detection system 100 has been described in detail while taking the case where the event detection processing and the anomaly cause estimation processing are executed in the management server 110, as an example. However, the information processing in the anomaly detection system 100 is not limited to the present embodiment. In another embodiment, the event detection processing and the anomaly cause estimation processing may be executed in the vehicle 20. In this case, the vehicle 20 may be an example of the information processing apparatus.

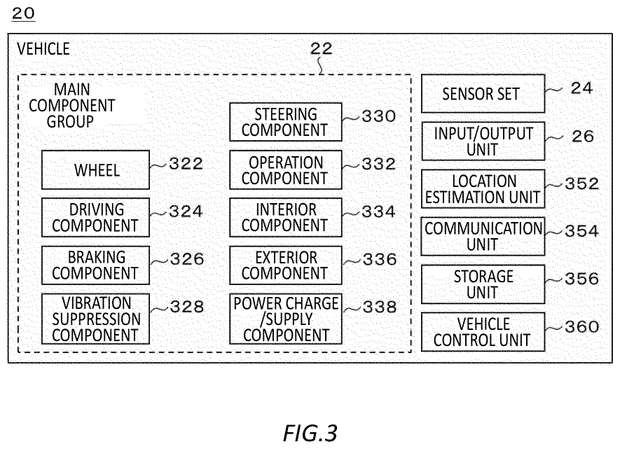

FIG. 3 schematically shows an example of an internal configuration of the vehicle 20. In the present embodiment, the vehicle 20 includes the main component group 22, the sensor set 24, the input/output unit 26, a location estimation unit 352, a communication unit 354, a storage unit 356, and a vehicle control unit 360. In the present embodiment, the main component group 22 includes a wheel 322, a driving component 324, a braking component 326, a vibration suppression component 328, a steering component 330, an operation component 332, an interior component 334, an exterior component 336, and a power charge/supply component 338.

In the present embodiment, each of the plurality of components included in the main component group 22 constitutes a part of the vehicle 20. At least one of the plurality of components included in the main component group 22 may further be constituted by a plurality of components.

In the present embodiment, the driving component 324 is used for driving the wheel 322.

Examples of the driving component 324 include a power component, a power transmission component, and the like. Examples of the power component or the power transmission component include a motor, a power clutch, a gear, a shaft, and the like.

In the present embodiment, the braking component 326 is used for braking the wheel 322. Examples of the braking component 326 include a brake system, a brake pad, a brake disc, a tire, and the like.

In the present embodiment, the vibration suppression component 328 is used for suppressing vibration of the vehicle 20. Examples of the vibration suppression component 328 include a suspension, a damper, a bush, and the like.

In the present embodiment, the steering component 330 is used for steering the vehicle 20. Examples of the steering component 330 include a steering, a steering column, a pinion shaft, an actuator, a tie rod, a knuckle, and the like.

In the present embodiment, the operation component 332 is used by the user of the vehicle 20 to operate the vehicle 20. Examples of the operation component 332 include an accelerator, a brake, a steering wheel, a shift lever, various operation switches, and the like.

In the present embodiment, the interior component 334 is arranged inside the vehicle 20. Examples of the interior component 334 include a seat, an acoustic absorbent, a mirror, a navigation system (may be referred to as navigation), a rearview monitor, an air conditioner, an interior light, a speaker, and the like.

In the present embodiment, the exterior component 336 is arranged outside the vehicle 20. Examples of the exterior component 336 include a door, a window, a wiper, a blinker, a headlight, a sideview mirror (including an electronic mirror), an exterior camera, and the like.

In the present embodiment, the power charge/supply component 338 is used to charge, store, or supply power. Examples of the power charge/supply component 338 include a charging connector, a charger, a converter, a battery, and the like.

In the present embodiment, the location estimation unit 352 estimates a location of the vehicle 20. A location estimation method is not limited in particular. In the present embodiment, the communication unit 354 transmits and receives information to/from external communication equipment via the communication network 10. An example of the external communication equipment is the management server 110. In the present embodiment, the storage unit 356 stores various types of information related to the vehicle 20. In one embodiment, the storage unit 356 stores information used in the information processing performed in the vehicle 20. In another embodiment, the storage unit 356 stores information generated by the information processing performed in the vehicle 20. In the present embodiment, the vehicle control unit 360 controls operations of the vehicle 20.

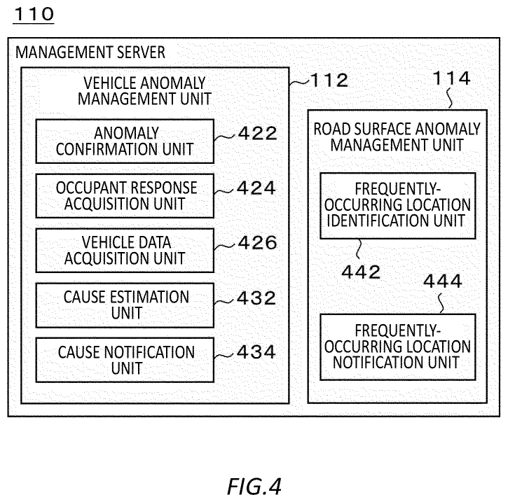

FIG. 4 schematically shows an example of an internal configuration of the management server 110. In the present embodiment, the vehicle anomaly management unit 112 includes an anomaly confirmation unit 422, an occupant response acquisition unit 424, a vehicle data acquisition unit 426, a cause estimation unit 432, and a cause notification unit 434. In the present embodiment, the road surface anomaly management unit 114 includes a frequently-occurring location identification unit 442 and a frequently-occurring location notification unit 444.

In the present embodiment, the anomaly confirmation unit 422 detects an occurrence of the one or more predetermined types of events described above. When the above-described event is detected, the anomaly confirmation unit 422 executes the anomaly confirmation processing described above.

In the present embodiment, the occupant response acquisition unit 424 acquires response data from each of the one or more vehicles 20. As described above, when the anomaly confirmation unit 422 detects an event, the occupant response acquisition unit 424 acquires response data from the vehicle 20 relevant to the event.

In the present embodiment, the vehicle data acquisition unit 426 acquires vehicle data of each of the one or more vehicles 20. As described above, the vehicle data may include information representing a time at which the sensor has output a measurement result, or may include information representing a location of the vehicle 20 at the time. The vehicle data acquisition unit 426 acquires vehicle data of a period having a predetermined length, which includes a time point at which the occurrence of the above-described event has been detected. Accordingly, the vehicle data acquisition unit 426 can acquire, for example, vehicle data obtained before and after a time point at which an occurrence of a particular event has been detected.

In one embodiment, when the anomaly confirmation unit 422 detects an event, the vehicle data acquisition unit 426 acquires vehicle data from the vehicle 20 relevant to the event. In another embodiment, the vehicle data acquisition unit 426 accesses a database which stores vehicle data transmitted periodically or at any timing from each of the one or more vehicles 20, and acquires vehicle data of the vehicle 20 relevant to the event detected by the anomaly confirmation unit 422, the vehicle data being vehicle data of a period having a predetermined length, which includes a time point at which the anomaly confirmation unit 422 has detected the event.

In the present embodiment, the cause estimation unit 432 estimates a cause of an anomaly sensed by the occupant 30. For example, the cause estimation unit 432 determines, out of the main component group 22, a component having a higher possibility of being a cause of the anomaly (may be referred to as cause component) than other components included in the main component group 22, to thus estimate a cause of the above-described anomaly.

In one embodiment, the cause estimation unit 432 estimates a cause of an anomaly based on vehicle data obtained when the occupant 30 has sensed the anomaly of the vehicle 20. In another embodiment, the cause estimation unit 432 estimates a cause of an anomaly based on vehicle data obtained when the occupant 30 has sensed the anomaly of the vehicle 20 and vehicle data obtained when the occupant 30 has not sensed an anomaly of the vehicle 20. The cause estimation unit 432 may estimate a cause of an anomaly based on (i) vehicle data obtained when the occupant 30 has sensed the anomaly of the vehicle 20 and (ii) vehicle data that is obtained when the occupant 30 has not sensed an anomaly of the vehicle 20 and is output most recent to a time point at which the occupant 30 has sensed the anomaly of the vehicle 20.

For example, vehicle data obtained when the occupant 30 has sensed an anomaly of the vehicle 20 is compared with vehicle data obtained when the occupant 30 has not sensed an anomaly of the vehicle 20, and a cause of the anomaly is estimated based on a result of the comparison. For example, a deterioration degree of each component, that is derived from vehicle data obtained when the occupant 30 has sensed an anomaly of the vehicle 20, is compared with a deterioration degree of each component, that is derived from vehicle data obtained when the occupant 30 has not sensed an anomaly of the vehicle 20, and a cause of the anomaly is estimated based on a result of the comparison.

In the present embodiment, when the cause estimation unit 432 estimates a cause of an anomaly related to a particular vehicle 20, the cause notification unit 434 notifies an owner or user of the particular vehicle 20 of information related to the cause of the anomaly estimated by the cause estimation unit 432. The cause notification unit 434 may transmit information related to the above-described cause of the anomaly to a communication terminal used by the owner or user of the above-described particular vehicle 20, or may transmit the information to the above-described particular vehicle 20.

In the present embodiment, the frequently-occurring location identification unit 442 identifies the frequent anomaly-occurring location described above. The frequently-occurring location identification unit 442 may identify the frequent anomaly-occurring location based on one or more pieces of response data and vehicle data collected from the one or more vehicles 20.

In the present embodiment, the frequently-occurring location notification unit 444 transmits information representing the frequent anomaly-occurring location to the information distribution server 120. As described above, the information distribution server 120 distributes traffic information including the information representing the frequent anomaly-occurring location to the one or more vehicles 20 or the owner or user thereof. Accordingly, the frequently-occurring location notification unit 444 can notify the one or more vehicles 20 or the owner or user thereof of the information representing the frequent anomaly-occurring location.

The anomaly confirmation unit 422 may be an example of the event detection unit. The occupant response acquisition unit 424 may be an example of a sensing information acquisition unit. The vehicle data acquisition unit 426 may be an example of a mobile object information acquisition unit. The frequently-occurring location identification unit 442 may be an example of an anomaly location identification unit. The frequently-occurring location notification unit 444 may be an example of an anomaly location notification unit. The other components included in the main component group 22 may be an example of the other components. The information representing a frequent anomaly-occurring location may be an example of anomaly location information. The traffic information may be an example of the anomaly location information.

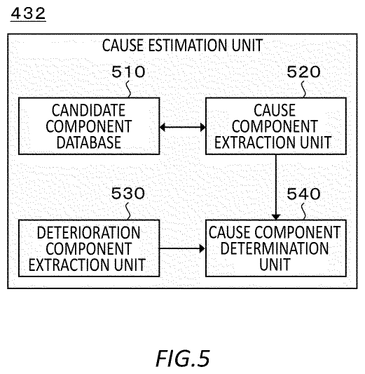

FIG. 5 schematically shows an example of an internal configuration of the cause estimation unit 432. In the present embodiment, the cause estimation unit 432 includes a candidate component database 510, a cause component extraction unit 520, a deterioration component extraction unit 530, and a cause component determination unit 540.

In the present embodiment, the candidate component database 510 stores various databases for extracting a cause component relevant to an anomaly sensed by the occupant 30 from the plurality of components included in the main component group 22. The above-described databases are constructed based on past data related to the one or more vehicles 20, for example. The above-described databases are constructed by subjecting the past data related to the one or more vehicles 20 to statistical processing, for example. The above-described databases are constructed by subjecting information related to a component that has been identified as a cause of an anomaly in the past to the statistical processing, for example.

Examples of the above-described databases include (i) a database which stores a usage status of the vehicle 20 at a time point at which an anomaly of the vehicle 20 is sensed and a type of a component that may become a cause of the anomaly under the usage status, in association with each other, (ii) a database which stores a type of an anomaly sensed by the occupant 30 and a type of a component that may become a cause of the sensed anomaly, in association with each other, and the like. The type of a component that may become a cause of an anomaly under the above-described usage status may be a type of a component that may become a cause of some kind of an anomaly under the usage status, or may be a type of a component that may become a cause of the sensed anomaly under the usage status.

In the present embodiment, the cause component extraction unit 520 extracts one or more cause component candidates from the plurality of components constituting the vehicle 20. The cause component extraction unit 520 may output information representing the one or more extracted cause component candidates to the cause component determination unit 540. Accordingly, the cause estimation unit 432 can estimate a component having a high possibility of being a cause of an anomaly as the cause of the anomaly.

For example, based on at least one of (a) a usage status of the vehicle 20 at a time point at which the anomaly confirmation unit 422 has detected an occurrence of an event or (b) a type of an anomaly sensed by the occupant 30 of the vehicle 20, the cause component extraction unit 520 extracts one or more cause component candidates from the plurality of components constituting the vehicle 20. As described above, of the plurality of components constituting the vehicle 20, the cause component is a component having a higher possibility of being a cause of an anomaly than other components.

For example, the cause component extraction unit 520 extracts one or more cause component candidates from the plurality of components included in the main component group 22. The cause component extraction unit 520 may extract one or more cause component candidates based on at least one of (a) a usage status of the vehicle 20 at a time point at which the anomaly confirmation unit 422 has detected an occurrence of an event or (b) a type of an anomaly sensed by the occupant 30 of the vehicle 20.

For example, the cause component extraction unit 520 references the various databases stored in the candidate component database 510, and extracts a cause component candidate of a particular vehicle 20 for which an anomaly has been sensed. In one embodiment, the cause component extraction unit 520 references the database which stores a usage status of the vehicle 20 at a time point at which an anomaly of the vehicle 20 has been sensed and a type of a component that may become a cause of an anomaly under the usage status in association with other, and extracts, as a cause component candidate, a component that matches with a usage status of a particular vehicle 20 for which the anomaly has been sensed. In another embodiment, the cause component extraction unit 520 references the database which stores a type of an anomaly sensed by the occupant 30 and a type of a component that may become a cause of the sensed anomaly in association with other, and extracts, as a cause component candidate, a component that matches with a type of an anomaly of a particular vehicle 20, that has been sensed by the occupant 30. The cause component extraction unit 520 will be described later in detail.

In the present embodiment, the deterioration component extraction unit 530 extracts, from the plurality of components constituting the vehicle 20, a component whose deterioration degree matches a predetermined condition (may be referred to as deterioration component). The cause component extraction unit 520 may output information representing one or more extracted deterioration components to the cause component determination unit 540. Accordingly, the cause estimation unit 432 can estimate a component whose deterioration degree matches the predetermined condition as a cause of an anomaly.

For example, for at least some of the plurality of components constituting the vehicle 20, the deterioration component extraction unit 530 determines a deterioration degree of the component. The deterioration component extraction unit 530 may determine the deterioration degree of the component for each of the main component groups 22. The deterioration component extraction unit 530 may determine the deterioration degree of the component for at least a part of the main component group 22.

The deterioration component extraction unit 530 may determine, based on vehicle data obtained when the occupant 30 has sensed an anomaly of the vehicle 20, the deterioration degree of the component for at least some of the plurality of components constituting the vehicle 20. Accordingly, the deterioration component extraction unit 530 can determine the deterioration degree of each component obtained when the occupant 30 has sensed an anomaly of the vehicle 20.

The deterioration component extraction unit 530 judges whether the deterioration degree of each component matches a predetermined condition for each of the one or more components for which the deterioration degrees have been determined. For example, for each of the one or more components for which the deterioration degrees have been determined, the deterioration component extraction unit 530 compares the deterioration degree of each component with a reference related to the deterioration degree, that has been predetermined for each component. Based on a result of the above-described comparison, the deterioration component extraction unit 530 extracts one or more deterioration components from the plurality of components constituting the vehicle 20.

In one embodiment, the deterioration component extraction unit 530 extracts one or more components whose deterioration degrees exceed the above-described reference, as the deterioration components. Of the one or more components whose deterioration degrees exceed the above-described reference, the deterioration component extraction unit 530 may extract a predetermined number of components as the deterioration components.

In another embodiment, the deterioration component extraction unit 530 may extract a deterioration component from components in each of which (i) the deterioration degree does not exceed the above-described reference and (i) a degree of deviation between the deterioration degree and the above-described reference matches a predetermined condition. An example of the predetermined condition is a condition that the degree of deviation between the deterioration degree and the above-described reference falls below a predetermined reference. Accordingly, the deterioration component extraction unit 530 can extract, from the components whose deterioration degrees do not exceed the above-described reference, a component having a small allowance with respect to the reference, as the deterioration component.

For example, when the number of components whose deterioration degrees exceed the above-described reference is smaller than a predetermined value, the deterioration component extraction unit 530 may extract a component from the components whose deterioration degrees do not exceed the above-described reference, in an ascending order of the degree of deviation between the deterioration degree and the above-described reference. Accordingly, the deterioration component extraction unit 530 can extract a predetermined number of components as the deterioration components.

In the present embodiment, the cause component determination unit 540 determines a cause component. As described above, the cause component determination unit 540 acquires information representing one or more cause component candidates from the cause component extraction unit 520. In addition, the cause component determination unit 540 acquires information representing one or more deterioration components from the deterioration component extraction unit 530. The cause component determination unit 540 may determine a cause component from the one or more cause component candidates and/or the one or more deterioration components.

In one embodiment, the cause component determination unit 540 determines at least one of the one or more cause component candidates as the cause component. For example, the cause component determination unit 540 determines the cause component based on a deterioration degree of each component obtained when the occupant 30 has not sensed an anomaly of the vehicle 20 and a deterioration degree of each component obtained when the occupant 30 has sensed an anomaly of the vehicle 20. The cause component determination procedure will be described later in detail.

In another embodiment, the cause component determination unit 540 determines at least one of the one or more deterioration components as the cause component. The cause component determination unit 540 may determine the cause component based on the deterioration degree of each of the one or more deterioration components. For example, the cause component determination unit 540 determines, as the cause component, a component having a largest deterioration degree out of the one or more deterioration components. For example, the cause component determination unit 540 determines, as the cause component, a component whose deterioration degree exceeds a predetermined reference out of the one or more deterioration components.

The candidate component database 510 may be an example of a first storage apparatus or a second storage apparatus.

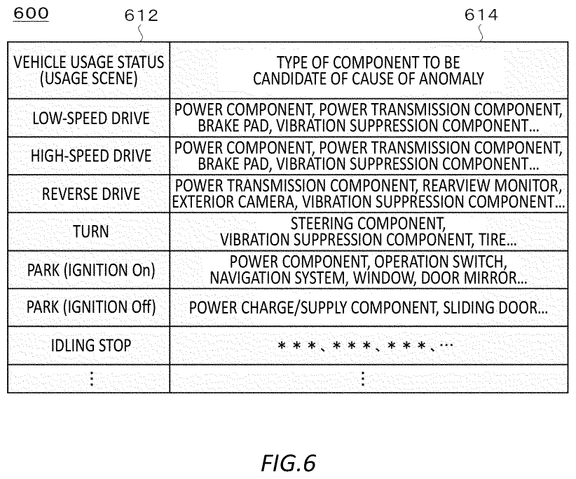

FIG. 6 schematically shows an example of a data structure of a database 600. The database 600 is stored in the candidate component database 510, for example.

In the present embodiment, the database 600 stores information 612 representing a usage status of the vehicle 20 at a time point at which the occupant 30 has sensed an anomaly of the vehicle 20 and information 614 representing a type of a component that may become a cause of an anomaly of the vehicle 20 under the usage status, in association with each other. The database 600 is generated based on, for example, an estimation result obtained in the cause estimation processing of the past or a record of a test or inspection of the past.

The database 600 may be an example of the first storage apparatus.

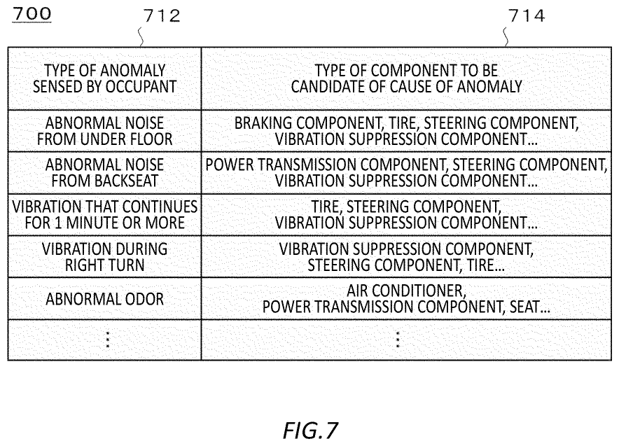

FIG. 7 schematically shows an example of a data structure of a database 700. The database 700 is stored in the candidate component database 510, for example.

In the present embodiment, the database 700 stores information 712 representing a type of an anomaly sensed by the occupant 30 and information 714 representing a type of a component identified as a cause of an anomaly of the vehicle 20, in association with each other. The database 700 is generated based on, for example, an estimation result obtained in the cause estimation processing of the past or a record of a test or inspection of the past.

The database 700 may be an example of the second storage apparatus.

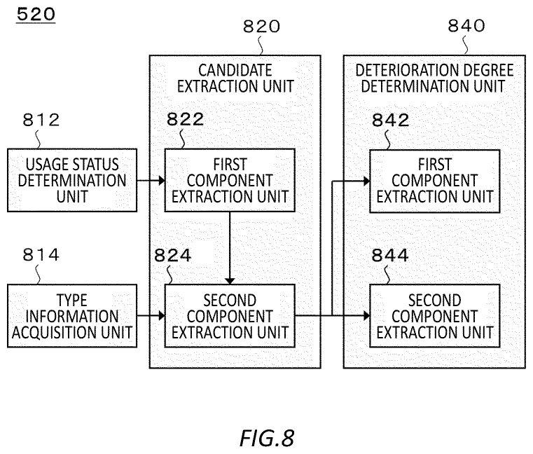

FIG. 8 schematically shows an example of an internal configuration of the cause component extraction unit 520. Using FIG. 8, the internal configuration of the cause component extraction unit 520 will be described in detail. Also by using FIG. 8, an example of a procedure in which the cause component determination unit 540 determines a cause component from an extraction result of the cause component extraction unit 520 will be described in detail.

(Details of Internal Configuration of Cause Component Extraction Unit 520)

In the present embodiment, the cause component extraction unit 520 includes a usage status determination unit 812, a type information acquisition unit 814, a candidate extraction unit 820, and a deterioration degree determination unit 840. In the present embodiment, the candidate extraction unit 820 includes a first component extraction unit 822 and a second component extraction unit 824. In the present embodiment, the deterioration degree determination unit 840 includes a first deterioration degree determination unit 842 and a second deterioration degree determination unit 844.

In the present embodiment, the usage status determination unit 812 determines a usage status of the vehicle 20 at a time point at which the anomaly confirmation unit 422 has detected an occurrence of an event. For example, the usage status determination unit 812 analyzes vehicle data of the vehicle 20 at a time point at which the anomaly confirmation unit 422 has detected an occurrence of an event, and determines the above-described usage status of the vehicle 20. The usage status determination unit 812 may determine the above-described usage status of the vehicle 20 based on a state of an operation input from the occupant 30, that is represented by the above-described vehicle data of the vehicle 20, and/or a state of the vehicle 20.

In the present embodiment, the type information acquisition unit 814 acquires information representing a type of an anomaly sensed by the occupant 30 (may be referred to as type information). For example, the type information acquisition unit 814 inquires of the occupant 30 on a type of an anomaly sensed by the occupant 30 via the input/output unit 26, to thus acquire type information.

More specifically, first, the type information acquisition unit 814 transmits, to the vehicle 20, an instruction for causing the vehicle 20 to execute processing for confirming a type of an anomaly sensed by the occupant 30 (may be referred to as type confirmation processing). When the vehicle 20 receives the above-described instruction, the input/output unit 26 inquires of the occupant 30 on a type of the anomaly sensed by the occupant 30. The above-described type of an anomaly may be confirmed by a single question, or may be confirmed by a plurality of questions.

Next, the input/output unit 26 accepts a response to the above-described inquiry from the occupant 30. The input/output unit 26 transmits response data representing a content of the response of the occupant 30 to the above-described inquiry, to the management server 110. Accordingly, the type information acquisition unit 814 can acquire the type information.

In the present embodiment, the candidate extraction unit 820 extracts one or more cause component candidates from the plurality of components constituting the vehicle 20 based on at least one of a usage status of the vehicle 20 at a time point at which the anomaly confirmation unit 422 has detected an occurrence of an event or a type of an anomaly sensed by the occupant 30 of the vehicle 20. The candidate extraction unit 820 may extract one or more cause component candidates from the plurality of components included in the main component group 22. The candidate extraction unit 820 may reference the candidate component database 510 to extract one or more cause component candidates that match with the current status.

In the present embodiment, the first component extraction unit 822 extracts, from the plurality of components constituting the vehicle 20, one or more components that match with the usage status of the vehicle 20 that has been determined by the usage status determination unit 812 (may be referred to as first component). For example, the first component extraction unit 822 references the database 600 stored in the candidate component database 510, and extracts, from the plurality of components constituting the vehicle 20, one or more first components corresponding to the usage status of the vehicle 20 that has been determined by the usage status determination unit 812. Accordingly, the first component extraction unit 822 can extract a component that may become a cause of the anomaly sensed by the occupant.

In the present embodiment, the second component extraction unit 824 extracts one or more components that match with a type of an anomaly represented by the type information acquired by the type information acquisition unit 814 (may be referred to as second component). For example, the second component extraction unit 824 references the database 700 stored in the candidate component database 510, and determines, from the one or more first components extracted by the first component extraction unit 822, one or more second components corresponding to the type of an anomaly represented by the type information acquired by the type information acquisition unit 814. Accordingly, the second component extraction unit 824 can extract a component that may become a cause of the anomaly sensed by the occupant.

In the present embodiment, the deterioration degree determination unit 840 determines a degree of deterioration (may be referred to as deterioration degree) of a component. For example, the deterioration degree determination unit 840 determines, for each component, a deterioration degree obtained when the occupant 30 has sensed an anomaly of the vehicle 20 (may be referred to as first deterioration degree) and a deterioration degree obtained when the occupant 30 has not sensed an anomaly of the vehicle 20 (may be referred to as second deterioration degree).

In the present embodiment, the deterioration degree determination unit 840 determines the deterioration degree of at least each of the one or more second components extracted by the second component extraction unit 824. The deterioration degree determination unit 840 may determine the deterioration degree of each of the plurality of components included in the main component group 22, or may determine the deterioration degree of each of the plurality of components constituting the vehicle 20. The deterioration degree determination unit 840 outputs identification information for identifying each component and information representing the deterioration degree of each component to the cause component determination unit 540 in association with each other.

In the present embodiment, the first deterioration degree determination unit 842 determines a first deterioration degree for each of the one or more second components. For example, the first deterioration degree determination unit 842 determines the first deterioration degree for each of the one or more second components based on vehicle data obtained when the occupant 30 has sensed an anomaly of the vehicle 20. More specifically, the first deterioration degree determination unit 842 accumulates a temperature and/or an input load of a torque during a period from a reference time point that has been set arbitrarily to a time point at which the above-described anomaly is sensed or detected, to thus determine the first deterioration degree of each component.

In the present embodiment, the second deterioration degree determination unit 844 determines a second deterioration degree for each of the one or more second components. For example, the second deterioration degree determination unit 844 determines the second deterioration degree for each of the one or more second components based on vehicle data obtained when the occupant 30 has not sensed an anomaly of the vehicle 20. More specifically, the second deterioration degree determination unit 844 accumulates a temperature and/or an input load of a torque during a period in which the above-described anomaly is not sensed or detected, to thus determine the second deterioration degree of each component.

### Example of Procedure for Determining Cause Component from Extraction Result of Cause Component Extraction Unit 520

In the present embodiment, the cause component determination unit 540 acquires, from the deterioration degree determination unit 840, information in which identification information of each of the one or more second components, the first deterioration degree of each component, that has been determined by the first deterioration degree determination unit 842, and the second deterioration degree of each component, that has been determined by the second deterioration degree determination unit 844, are associated with one another. The cause component determination unit 540 performs comparison of the first deterioration degree and the second deterioration degree for each of the one or more second components, and determines a cause component based on a result of the comparison.

In one embodiment, the cause component determination unit 540 determines, as the cause component, a second component whose difference between the first deterioration degree and the second deterioration degree matches a predetermined condition out of the one or more second components. For example, the cause component determination unit 540 determines, as the cause component, a second component whose deterioration progression degree indicated by a difference between the first deterioration degree and the second deterioration degree exceeds a predetermined reference out of the one or more second components.

In another embodiment, the cause component determination unit 540 determines, as the cause component, a second component whose ratio of the first deterioration degree to the second deterioration degree matches a predetermined condition out of the one or more second components. For example, the cause component determination unit 540 determines, as the cause component, a second component whose deterioration progression degree indicated by the ratio of the first deterioration degree to the second deterioration degree exceeds a predetermined reference out of the one or more second components.

Further in another embodiment, the cause component determination unit 540 determines, as the cause component, a second component whose first deterioration degree has exceeded a predetermined reference out of the one or more second components. When the number of second components whose first deterioration degrees have exceeded a predetermined reference is two or more, the cause component determination unit 540 (i) may determine a single cause component or a predetermined number of cause components based on a degree of deviation from the above-described reference, or (ii) may present all second components whose first deterioration degrees have exceeded a predetermined reference, as the cause component candidates. The cause component determination unit 540 may determine, as the cause component, a second component having a largest ratio by which the above-described reference is exceeded, or may determine the cause component in a descending order of the ratio by which the above-described reference is exceeded.

The response data may be an example of the type information.

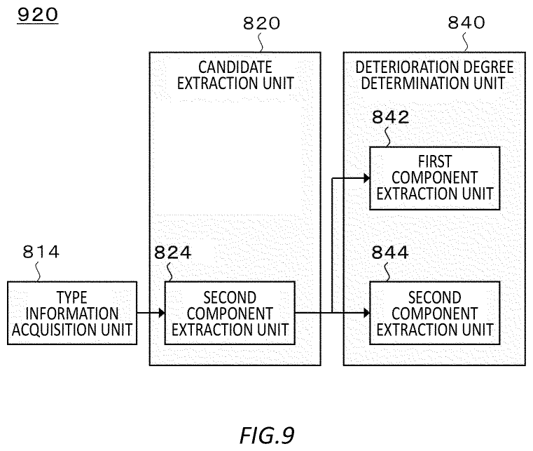

FIG. 9 schematically shows an example of an internal configuration of a cause component extraction unit 920. The cause component extraction unit 920 may be another example of the cause component extraction unit 520. The cause component extraction unit 920 may have a configuration similar to that of the cause component extraction unit 520 except that the usage status determination unit 812 and the first component extraction unit 822 are not provided and that the second component extraction unit 824 extracts one or more second components from the plurality of components constituting the vehicle 20. The second component extraction unit 824 may extract one or more second components from the plurality of components included in the main component group 22. For example, the second component extraction unit 824 references the database 700 and extracts one or more second components from the above-described plurality of components.

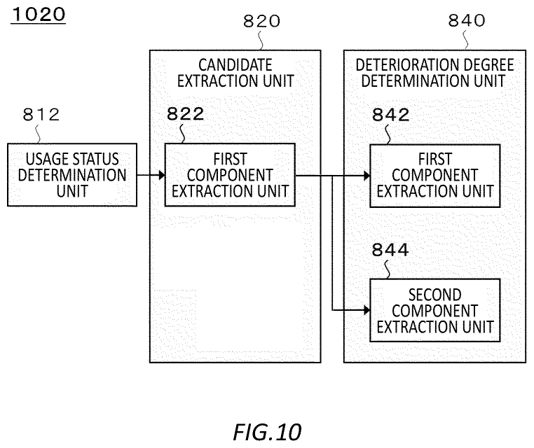

FIG. 10 schematically shows an example of an internal configuration of a cause component extraction unit 1020. The cause component extraction unit 1020 may be another example of the cause component extraction unit 520. The cause component extraction unit 1020 may have a configuration similar to that of the cause component extraction unit 520 except that the type information acquisition unit 814 and the second component extraction unit 824 are not provided, that the first deterioration degree determination unit 842 determines the first deterioration degree for each of the one or more first components, and that the second deterioration degree determination unit 844 determines the second deterioration degree for each of the one or more first components.

In the present embodiment, the first deterioration degree determination unit 842 determines, based on vehicle data obtained when the occupant 30 has sensed an anomaly of the vehicle 20, the first deterioration degree which is a deterioration degree obtained when the occupant 30 has sensed an anomaly of the vehicle 20, for at least each of the one or more first components. In the present embodiment, the second deterioration degree determination unit 844 determines, based on vehicle data obtained when the occupant 30 has not sensed an anomaly of the vehicle 20, the second deterioration degree which is a deterioration degree obtained when the occupant 30 has not sensed an anomaly of the vehicle 20, for at least each of the one or more first components. In the present embodiment, the cause component determination unit 540 performs comparison of the first deterioration degree and the second deterioration degree of each of the one or more first components, and determines a cause component based on a result of the comparison, for example.

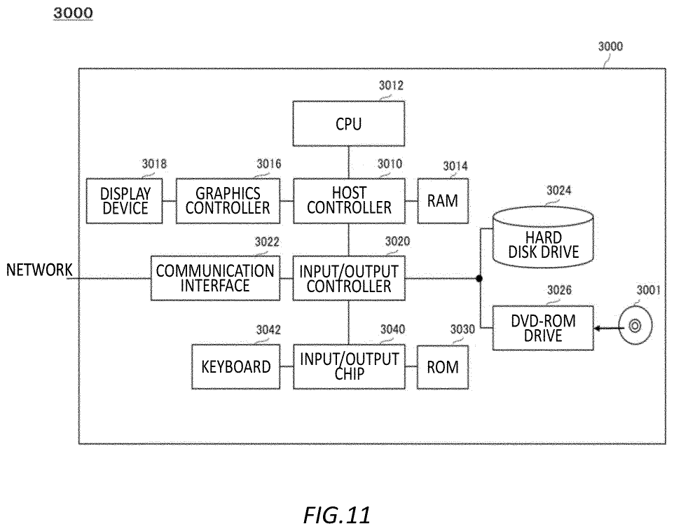

FIG. 11 shows an example of a computer 3000 in which a plurality of aspects of the present invention may be entirely or partly embodied. For example, at least a part of the anomaly detection system 100 is realized by the computer 3000. For example, at least a part of the management server 110 is realized by the computer 3000. For example, at least a part of the information distribution server 120 is realized by the computer 3000. For example, at least a part of the vehicle control unit 360 is realized by the computer 3000.

A program that is installed in the computer 3000 can cause the computer 3000 to perform an operation associated with an apparatus according to the embodiment of the present invention or to function as one or more “units” of the apparatus, or cause the computer 3000 to perform the operation or the one or more “units” thereof, and/or cause the computer 3000 to perform processes according to the embodiment of the present invention or steps thereof. Such a program may be performed by a CPU 3012 to cause the computer 3000 to perform particular operations associated with some or all of the blocks of flowcharts and block diagrams described herein.

The computer 3000 according to the present embodiment includes the CPU 3012, a RAM 3014, a GPU 3016, and a display device 3018, which are mutually connected by a host controller 3010. The computer 3000 also includes an input/output unit such as a communication interface 3022, a hard disk drive 3024, a DVD-ROM drive 3026, and an IC card drive, which are connected to the host controller 3010 via an input/output controller 3020. The computer also includes legacy input/output units such as a ROM 3030 and a keyboard 3042, which are connected to the input/output controller 3020 via an input/output chip 3040.

The CPU 3012 operates according to programs stored in the ROM 3030 and the RAM 3014, thereby controlling each unit. The GPU 3016 acquires image data generated by the CPU 3012 on a frame buffer or the like provided in the RAM 3014 or in itself, and causes the image data to be displayed on the display device 3018.

The communication interface 3022 communicates with other electronic devices via a network. The hard disk drive 3024 stores programs and data that are used by the CPU 3012 within the computer 3000. The DVD-ROM drive 3026 reads the programs or the data from the DVD-ROM 3001, and provides the hard disk drive 3024 with the programs or the data via the RAM 3014. The IC card drive reads programs and data from an IC card and/or writes programs and data into the IC card.

The ROM 3030 stores therein a boot program or the like that is performed by the computer 3000 at the time of activation, and/or a program depending on the hardware of the computer 3000. The input/output chip 3040 may also connect various input/output units to the input/output controller 3020 via a parallel port, a serial port, a keyboard port, a mouse port, or the like.

A program is provided by a computer-readable storage medium such as the DVD-ROM 3001 or the IC card. The program is read from the computer-readable storage medium, installed into the hard disk drive 3024, RAM 3014, or ROM 3030, which are also examples of the computer-readable storage medium, and performed by the CPU 3012. The information processing described in these programs is read into the computer 3000, resulting in cooperation between a program and the above-described various types of hardware resources. An apparatus or method may be constituted by realizing the operation or processing of information in accordance with the usage of the computer 3000.

For example, when communication is performed between the computer 3000 and an external device, the CPU 3012 may perform a communication program loaded onto the RAM 3014 to instruct communication processing to the communication interface 3022, based on the processing described in the communication program. The communication interface 3022, under the control of the CPU 3012, reads the transmission data stored in the transmission buffer area provided in the recording medium such as the RAM 3014, the hard disk drive 3024, the DVD-ROM 3001, or the IC card, and transmits the read transmission data to the network or writes reception data received from the network to the reception buffer area provided on the recording medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), and the IC card, and perform various types of processing on the data on the RAM 3014. The CPU 3012 may then write back the processed data to the external recording medium.

Various types of information such as various types of programs, data, tables, and databases may be stored in a recording medium and subjected to information processing. The CPU 3012 may perform various types of processing on the data read from the RAM 3014, which includes various types of operations, information processing, condition judging, conditional branch, unconditional branch, search/replacement of information, and the like, as described throughout the present disclosure and designated by an instruction sequence of programs, and writes the result back to the RAM 3014. In addition, the CPU 3012 may search for information in a file, a database, or the like in the recording medium. For example, when a plurality of entries, each having an attribute value of a first attribute associated with an attribute value of a second attribute, are stored in the recording medium, the CPU 3012 may search for an entry whose attribute value of the first attribute matches a designated condition, from among the plurality of entries, and read the attribute value of the second attribute stored in the entry, thereby acquiring the attribute value of the second attribute associated with the first attribute satisfying the predetermined condition.

The program or software modules described above may be stored in the computer-readable storage medium on or near the computer 3000. In addition, a recording medium such as a hard disk or a RAM provided in a server system connected to a dedicated communication network or the Internet can be used as the computer-readable storage medium, thereby providing the program to the computer 3000 via the network.

While the embodiments of the present invention have been described, the technical scope of the invention is not limited to the above described embodiments. It is apparent to persons skilled in the art that various alterations and improvements can be added to the above-described embodiments. In addition, the matters described with regard to the particular embodiment can be applied to other embodiments with a range without causing technical contradictions. It is also apparent from the description of the claims that the embodiments to which such alterations or improvements are made can be included in the technical scope of the present invention.

The operations, procedures, steps, and stages of each process performed by an apparatus, system, program, and method shown in the claims, specification, or drawings can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

10: communication network; 20: vehicle; 22: main component group; 24: sensor set; 26: input/output unit; 30: occupant; 100: anomaly detection system; 110: management server; 112: vehicle anomaly management unit; 114: road surface anomaly management unit; 120: information distribution server; 322: wheel; 324: driving component; 326: braking component; 328: vibration suppression component; 330: steering component; 332: operation component; 334: interior component; 336: exterior component; 338: power charge/supply component; 352: location estimation unit; 354: communication unit; 356: storage unit; 360: vehicle control unit; 422: anomaly confirmation unit; 424: occupant response acquisition unit; 426: vehicle data acquisition unit; 432: cause estimation unit; 434: cause notification unit; 442: frequently-occurring location identification unit; 444: frequently-occurring location notification unit; 510: candidate component database; 520: cause component extraction unit; 530: deterioration component extraction unit; 540: cause component determination unit; 600: database; 612: information; 614: information; 700: database; 712: information; 714: information; 812: usage status determination unit; 814: type information acquisition unit; 820: candidate extraction unit; 822: first component extraction unit; 824: second component extraction unit; 840: deterioration degree determination unit; 842: first deterioration degree determination unit; 844: second deterioration degree determination unit; 920: cause component extraction unit; 1020: cause component extraction unit; 3000: computer; 3001: DVD-ROM; 3010: host controller; 3012: CPU; 3014: RAM; 3016: GPU; 3018: display device; 3020: input/output controller; 3022: communication interface; 3024: hard disk drive; 3026: DVD-ROM drive; 3030: ROM; 3040: input/output chip; 3042: keyboard.

What is claimed is:

1. An information processing apparatus, comprising:
an event detection unit configured to detect an occurrence of one or more predetermined types of events;
a sensing information acquisition unit configured to acquire, when the occurrence of an event is detected by the event detection unit, sensing information representing whether an occupant of a mobile object has sensed an anomaly of the mobile object;
a mobile object information acquisition unit configured to acquire mobile object information of a period having a predetermined length, which includes a time point at which the event detection unit has detected the occurrence of the event, the mobile object information being information representing an output of a sensor mounted on the mobile object or information representing a state of the mobile object that has been determined based on the output; and
a cause estimation unit configured to estimate a cause of the anomaly based on the mobile object information obtained when the occupant has sensed the anomaly of the mobile object.

2. The information processing apparatus according to claim 1, wherein
the cause estimation unit is configured to estimate the cause of the anomaly based on the mobile object information obtained when the occupant has not sensed the anomaly of the mobile object and the mobile object information obtained when the occupant has sensed the anomaly of the mobile object.

3. The information processing apparatus according to claim 1, wherein
the cause estimation unit includes:
a cause component extraction unit configured to extract, based on at least one of (a) a usage status of the mobile object at the time point at which the event detection unit has detected the occurrence of the event or (b) a type of the anomaly sensed by the occupant of the mobile object, a candidate of a cause component which is, out of a plurality of components constituting the mobile object, a component having a higher possibility of being the cause of the anomaly than other components.

4. The information processing apparatus according to claim 2, wherein
the cause estimation unit includes:
a cause component extraction unit configured to extract, based on at least one of (a) a usage status of the mobile object at the time point at which the event detection unit has detected the occurrence of the event or (b) a type of the anomaly sensed by the occupant of the mobile object, a candidate of a cause component which is, out of a plurality of components constituting the mobile object, a component having a higher possibility of being the cause of the anomaly than other components.

5. The information processing apparatus according to claim 3, further comprising:
a usage status determination unit configured to determine the usage status of the mobile object at the time point at which the event detection unit has detected the occurrence of the event,
wherein the cause component extraction unit includes:
a first component extraction unit configured to reference a first storage apparatus configured to store information representing a usage status of a mobile object and information representing a type of a component that may become a cause of an anomaly of the mobile object under the usage status, in association with each other, to extract, from the plurality of components constituting the mobile object, one or more first components that may become a cause of the anomaly sensed by the occupant, the one or more first components corresponding to the usage status of the mobile object that has been determined by the usage status determination unit.

6. The information processing apparatus according to claim 4, further comprising:
a usage status determination unit configured to determine the usage status of the mobile object at the time point at which the event detection unit has detected the occurrence of the event,
wherein the cause component extraction unit includes:
a first component extraction unit configured to reference a first storage apparatus configured to store information representing a usage status of a mobile object and information representing a type of a component that may become a cause of an anomaly of the mobile object under the usage status, in association with each other, to extract, from the plurality of components constituting the mobile object, one or more first components that may become a cause of the anomaly sensed by the occupant, the one or more first components corresponding to the usage status of the mobile object that has been determined by the usage status determination unit.

7. The information processing apparatus according to claim 5, further comprising:
a type information acquisition unit configured to acquire type information representing the type of the anomaly sensed by the occupant,
wherein the cause component extraction unit further includes:
a second component extraction unit configured to reference a second storage apparatus configured to store information representing a type of an anomaly sensed by one or more occupants on board one or more mobile objects and information representing a type of a component identified as a cause of the anomaly of the one or more mobile objects, in association with each other, to determine, from the one or more first components extracted by the first component extraction unit, one or more second components that may become the cause of the anomaly sensed by the occupant, the one or more second components corresponding to the type of the anomaly represented by the type information acquired by the type information acquisition unit.

8. The information processing apparatus according to claim 3, further comprising:
a type information acquisition unit configured to acquire type information representing the type of the anomaly sensed by the occupant,
wherein the cause component extraction unit includes:
a second component extraction unit configured to reference a second storage apparatus configured to store information representing a type of an anomaly sensed by one or more occupants on board one or more mobile objects and information representing a type of a component identified as a cause of the anomaly of the one or more mobile objects, in association with each other, to extract, from the plurality of components constituting the mobile object, one or more second components that may become the cause of the anomaly sensed by the occupant, the one or more second components corresponding to the type of the anomaly represented by the type information acquired by the type information acquisition unit.

9. The information processing apparatus according to claim 7, wherein
the cause component extraction unit further includes:
a first deterioration degree determination unit configured to determine, based on the mobile object information obtained when the occupant has sensed the anomaly of the mobile object, a first deterioration degree which is a deterioration degree obtained when the occupant has sensed the anomaly of the mobile object, for at least each of the one or more second components;
a second deterioration degree determination unit configured to determine, based on the mobile object information obtained when the occupant has not sensed the anomaly of the mobile object, a second deterioration degree which is a deterioration degree obtained when the occupant has not sensed the anomaly of the mobile object, for at least each of the one or more second components; and
a cause component determination unit configured to perform comparison of the first deterioration degree and the second deterioration degree of each of the one or more second components, and determine the cause component based on a result of the comparison.

10. The information processing apparatus according to claim 8, wherein
the cause component extraction unit further includes:
a first deterioration degree determination unit configured to determine, based on the mobile object information obtained when the occupant has sensed the anomaly of the mobile object, a first deterioration degree which is a deterioration degree obtained when the occupant has sensed the anomaly of the mobile object, for at least each of the one or more second components;
a second deterioration degree determination unit configured to determine, based on the mobile object information obtained when the occupant has not sensed the anomaly of the mobile object, a second deterioration degree which is a deterioration degree obtained when the occupant has not sensed the anomaly of the mobile object, for at least each of the one or more second components; and
a cause component determination unit configured to perform comparison of the first deterioration degree and the second deterioration degree of each of the one or more second components, and determine the cause component based on a result of the comparison.

11. The information processing apparatus according to claim 5, wherein
the cause component extraction unit further includes:
a first deterioration degree determination unit configured to determine, based on the mobile object information obtained when the occupant has sensed the anomaly of the mobile object, a first deterioration degree which is a deterioration degree obtained when the occupant has sensed the anomaly of the mobile object, for at least each of the one or more first components;
a second deterioration degree determination unit configured to determine, based on the mobile object information obtained when the occupant has not sensed the anomaly of the mobile object, a second deterioration degree which is a deterioration degree obtained when the occupant has not sensed the anomaly of the mobile object, for at least each of the one or more first components; and
a cause component determination unit configured to perform comparison of the first deterioration degree and the second deterioration degree of each of the one or more first components, and determine the cause component based on a result of the comparison.

12. The information processing apparatus according to claim 1, wherein
the cause estimation unit is configured to:
determine, based on the mobile object information obtained when the occupant has sensed the anomaly of the mobile object, a deterioration degree obtained when the occupant has sensed the anomaly of the mobile object, for at least some of a plurality of components constituting the mobile object; and
estimate a component having the deterioration degree matching a predetermined condition as the cause of the anomaly.

13. The information processing apparatus according to claim 1, wherein
the event includes at least one of (i) an elapse of a predetermined period, (ii) an arrival of a predetermined time, (iii) an input of a predetermined type of instruction related to an operation of the mobile object, (iv) a match of a behavior of the occupant with a predetermined condition, (v) a match of the output of the sensor with a predetermined condition, or (vi) a match of the state of the mobile object with a predetermined condition.

14. The information processing apparatus according to claim 2, wherein
the event includes at least one of (i) an elapse of a predetermined period, (ii) an arrival of a predetermined time, (iii) an input of a predetermined type of instruction related to an operation of the mobile object, (iv) a match of a behavior of the occupant with a predetermined condition, (v) a match of the output of the sensor with a predetermined condition, or (vi) a match of the state of the mobile object with a predetermined condition.

15. The information processing apparatus according to claim 1, further comprising:
a cause notification unit configured to notify an owner or user of the mobile object of information related to the cause of the anomaly that has been estimated by the cause estimation unit.

16. The information processing apparatus according to claim 2, further comprising:
a cause notification unit configured to notify an owner or user of the mobile object of information related to the cause of the anomaly that has been estimated by the cause estimation unit.

17. The information processing apparatus according to claim 1, wherein
the mobile object information includes location information representing a location where an occupant of each of one or more of the mobile objects has sensed an anomaly, and the information processing apparatus further comprises:
an anomaly location identification unit configured to identify, based on one or more pieces of the location information, a location where a frequency at which the anomaly is sensed is higher than a predetermined value; and
an anomaly location notification unit configured to notify the one or more mobile objects or an owner or user of each of the one or more mobile objects of anomaly location information representing the location identified by the anomaly location identification unit.

18. The information processing apparatus according to claim 2, wherein
the mobile object information includes location information representing a location where an occupant of each of one or more of the mobile objects has sensed an anomaly, and the information processing apparatus further comprises:
an anomaly location identification unit configured to identify, based on one or more pieces of the location information, a location where a frequency at which the anomaly is sensed is higher than a predetermined value; and
an anomaly location notification unit configured to notify the one or more mobile objects or an owner or user of each of the one or more mobile objects of anomaly location information representing the location identified by the anomaly location identification unit.

19. A non-transitory computer-readable storage medium having stored thereon a program for causing a computer to function as an information processing apparatus,
the information processing apparatus including:
an event detection unit configured to detect an occurrence of one or more predetermined types of events;
a sensing information acquisition unit configured to acquire, when the occurrence of an event is detected by the event detection unit, sensing information representing whether an occupant of a mobile object has sensed an anomaly of the mobile object;
a mobile object information acquisition unit configured to acquire mobile object information of a period having a predetermined length, which includes a time point at which the event detection unit has detected the occurrence of the event, the mobile object information being information representing an output of a sensor mounted on the mobile object or information representing a state of the mobile object that has been determined based on the output; and
a cause estimation unit configured to estimate a cause of the anomaly based on the mobile object information obtained when the occupant has sensed the anomaly of the mobile object.

20. An information processing method, comprising:
detecting an occurrence of one or more predetermined types of events;
acquiring, when the occurrence of an event is detected in the detecting, sensing information representing whether an occupant of a mobile object has sensed an anomaly of the mobile object;
acquiring mobile object information of a period having a predetermined length, which includes a time point at which the occurrence of the event has been detected in the detecting, the mobile object information being information representing an output of a sensor mounted on the mobile object or information representing a state of the mobile object that has been determined based on the output; and
estimating a cause of the anomaly based on the mobile object information obtained when the occupant has sensed the anomaly of the mobile object.
